(19) United States
(12) Patent Application Publication
(10) Pub. No.: US 2024/0276272 A1
(43) Pub. Date: Aug. 15, 2024

(54) PRIORITIZATION CRITERIA FOR POSITIONING MEASUREMENTS IN A TIME WINDOW MEASUREMENT SCHEME

(71) Applicant: QUALCOMM Incorporated, San Diego, CA (US)

(72) Inventors: Alexandros MANOLAKOS, Escondido, CA (US); Mukesh KUMAR, Hyderabad (IN); Srinivas YERRAMALLI, San Diego, CA (US)

(21) Appl. No.: 18/567,509

(22) PCT Filed: Jun. 3, 2022
(86) PCT No.: PCT/US2022/032049

§ 371 Date: Dec. 6, 2023

(30) Foreign Application Priority Data
Aug. 2, 2021 (GR) 20210100525

(51) Int. Cl. H04W 24/10; H04L 5/00

(52) U.S. Cl. CPC H04W 24/10; H04L 5/0051

(57) ABSTRACT

Techniques are discussed herein for prioritizing and reporting reference signal measurements relative to a time window. An example method for measuring positioning reference signals includes obtaining positioning reference signal configuration information, obtaining preferred measurement reporting window information, determining priority values for a plurality of positioning reference signals, wherein each priority value for a respective positioning reference signal is based at least in part on the positioning reference signal configuration information and the preferred measurement reporting window information, and reporting measurement values for one or more of the plurality of positioning reference signals based on the priority value.

### CROSS-REFERENCE TO RELATED APPLICATION

This application claims the benefit of Greek Patent Application No. 20210100525, filed Aug. 2, 2021, entitled “PRIORITIZATION CRITERIA FOR POSITIONING MEASUREMENTS IN A TIME WINDOW MEASUREMENT SCHEME,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, asset tracking, locating a friend or family member, etc. Existing positioning methods include methods based on measuring radio signals transmitted from a variety of devices including satellite vehicles and terrestrial radio sources in a wireless network such as base stations and access points. Stations in a wireless network may be configured to transmit reference signals to enable mobile device to perform positioning measurements. Improvements in position related signaling may improve the efficiency of mobile devices.

### SUMMARY

An example method for measuring positioning reference signals according to the disclosure includes obtaining positioning reference signal configuration information, obtaining preferred measurement reporting window information, determining priority values for a plurality of positioning reference signals, wherein each priority value for a respective positioning reference signal is based at least in part on the positioning reference signal configuration information and the preferred measurement reporting window information, and reporting measurement values for one or more of the plurality of positioning reference signals based on the priority value.

Implementations of such a method may include one or more of the following features. The preferred measurement reporting window information may include a time value and a delta time value, such that a preferred measurement reporting window may be a period of time equal to the time value minus the delta time value to the time value plus the delta time value. Determining the priority value for the plurality of positioning reference signals may include determining a first set of positioning reference signals to be measured inside of the preferred measurement reporting window and a second set of positioning reference signals to be measured outside of the preferred measurement reporting window, such that each positioning reference signal in the first set of positioning reference signals will have a higher priority than any positioning reference signal in the second set of positioning reference signals. The first set of positioning reference signals and the second set of positioning reference signals may be respectively sorted based on the measurement values for each of the positioning reference signals. The second set of positioning reference signals may be limited to one or more positioning reference signals received to the left of the preferred measurement reporting window. The second set of positioning reference signals may be limited to one or more positioning reference signals received to the right of the preferred measurement reporting window. The first set of positioning reference signals and the second set of positioning reference signals may be respectively sorted based on distance values measured from the time value for each of the positioning reference signals. The second set of positioning reference signals may be limited to one or more positioning reference signals received to the left of the preferred measurement reporting window. The second set of positioning reference signals may be limited to one or more positioning reference signals received to the right of the preferred measurement reporting window. Obtaining measurements for the one or more of the plurality of positioning reference signals based on the priority value. The positioning reference signal configuration information may include legacy priority values for one or more positioning reference signals, and the first set of positioning reference signals and the second set of positioning reference signals may be respectively sorted based at least in part on the legacy priority values for the one or more positioning reference signals. Obtaining measurements for the one or more of the plurality of positioning reference signals based on the legacy priority values. At least one of the plurality of positioning reference signals may be a downlink positioning reference signal. At least one of the plurality of positioning reference signals may be a sidelink positioning reference signal. At least one of the plurality of positioning reference signals may be a sounding reference signal for positioning. The preferred measurement reporting window information may be associated with a scheduled in advance measurement window.

An example method for providing a reference signal prioritization scheme according to the disclosure includes receiving a request for a future location of a user equipment, determining time window information based on the request for the future location of the user equipment, determining the reference signal prioritization scheme based at least in part on the time window information and a context of the user equipment, and providing the reference signal prioritization scheme to the user equipment.

Implementations of such a method may include one or more of the following features. The request for the future location of the user equipment may be received from a location services entity. The request for the future location of the user equipment may include the time window information. The reference signal prioritization scheme may include prioritizing a first set of positioning reference signals measured within a preferred measurement reporting window over as second set of positioning reference signals measured outside of the preferred measurement reporting window. The reference signal prioritization scheme may include prioritizing a plurality of positioning reference signals based on measurement values obtained for each of the plurality of positioning reference signals. The reference signal prioritization scheme may include prioritizing a plurality of positioning reference signals based on a time that each of the plurality of positioning reference signals is measured. The reference signal prioritization scheme may includes prioritizing a plurality of positioning reference signals based on legacy positioning reference signal priority values assigned by a base station.

An example apparatus according to the disclosure includes a memory, at least one transceiver, at least one processor communicatively coupled to the memory and the at least one transceiver, and configured to obtain positioning reference signal configuration information, obtain preferred measurement reporting window information, determine priority values for a plurality of positioning reference signals, wherein each priority value for a respective positioning reference signal is based at least in part on the positioning reference signal configuration information and the preferred measurement reporting window information, and report measurement values for one or more of the plurality of positioning reference signals based on the priority value.

An example apparatus according to the disclosure includes a memory, at least one transceiver, at least one processor communicatively coupled to the memory and the at least one transceiver, and configured to receive a request for a future location of a user equipment, determine time window information based on the request for the future location of the user equipment, determine a reference signal prioritization scheme based at least in part on the time window information and a context of the user equipment, and provide the reference signal prioritization scheme to the user equipment.

Items and/or techniques described herein may provide one or more of the following capabilities, as well as other capabilities not mentioned. A location services application may request location information for a user equipment for a future time. A communications network may provide assistance data including reference signal information to the user equipment in a pre-positioning process prior to requesting location information at the future time. A preferred measurement reporting window for obtaining reference signal measurements around the future time may be provided to the user equipment. Reference signal measurements may be obtained and reported at the future time. Reference signals obtained within the preferred measurement reporting window may have a higher priority than reference signals obtained outside the preferred measurement reporting window. Reference signal measurement and reporting prioritization schemes may utilize other factors such as reference signal measurement values and timestamp information. A location server may be configured to select a prioritization scheme based on a context of the user equipment at the future time. The accuracy of position estimates may be improved and the latency of providing location results may be reduced. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIGS. 5A and 5B illustrate example downlink positioning reference signal resource sets.

FIG. 6 is an illustration of example subframe formats for positioning reference signal transmission.

FIG. 7 is a diagram of an example positioning frequency layer.

FIG. 8 is a diagram of example downlink positioning reference signals.

FIG. 9 is a diagram of example sidelink positioning reference signals.

FIGS. 10A and10B include an example message flow for obtaining location information in a time window.

FIG. 11 is an example diagram of positioning reference signal measurements obtained relative to a time window.

FIG. 12 is a process flow of an example method for measuring positioning reference signals based on priority values.

FIGS. 13-18 are process flows of example methods for reporting positioning reference signal measurements based on receive times relative to a time window.

FIG. 19 is a process flow of an example method for providing a reference signal prioritization scheme to one or more wireless nodes.

### DETAILED DESCRIPTION

Techniques are discussed herein for prioritizing and reporting reference signal measurements relative to a time window. In some positioning applications, a user equipment (UE), location services (LCS) client, or other network entity may request to obtain the location of a target UE at a future time. In one example, a requesting entity may desire periodic location updates including future updates at different intervals. In an industrial internet of things (TTOT) use case, such as utilized in factories or warehouses with moving tools, components, packages, etc., there may be an expectation of when a moving tool, component or package, etc. will reach a specific location or will have completed a specific movement or operation. It may be useful to locate the tool, component or package, etc. to confirm the expectation and make any further adjustments. In other use cases, the locations of UEs may be scheduled to occur at specific times in the future. For example, vehicles on a road may all be located at the same time to provide an indication of traffic congestion as well as to assist with vehicle-to-everything (V2X) message traffic. People, containers, transportation systems, etc., may also be located at certain common times. In these and other such use cases, the known time (e.g., a scheduled location time) may be provided to network nodes in advance to reduce the effective latency in providing location results.

In operation, a network entity may request a UE to report positioning reference signal (PRS) measurements around a future time ‘T.’ The network entity may also provide a delta (A) parameter to define a measurement reporting period around the time ‘T’ (e.g., T−A to T+A). The number of PRS a UE is capable of processing may be limited. The techniques provided herein enable the UE to prioritize the PRS measurements and/or reports relative to the time window defined by the time ‘T’ and the A parameter. In an example, the PRS measured within the time window (e.g., T−A to T+A) may be prioritized above PRS measured outside of the time window. PRS may also be sorted or prioritized based on relative measurement values and time stamp information relative to the time ‘T.’ The UE may utilize different prioritization options to report one or more PRS measurements to the network entity. These techniques and configurations are examples, and other techniques and configurations may be used.

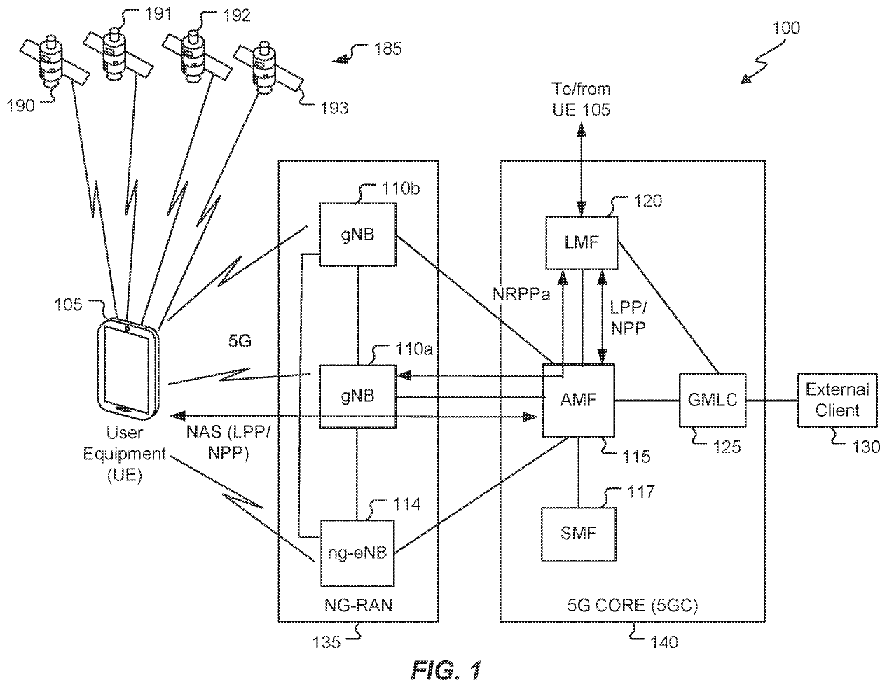

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 1l0b and the ng-eNB 114 are communicatively coupled to each other, are each configured to bi-directionally wirelessly communicate with the UE 105, and are each communicatively coupled to, and configured to bi-directionally communicate with, the AMF 115. The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 15, the SMF 117, the ng-eNB (eNodeB) 114 and the gNBs (gNodeBs) 100a, 110b are examples and may, in various embodiments, be replaced by or include various other location server functionality and/or base station functionality respectively.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the extemal client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%/95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (I:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 100a and 100b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-cNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications. The LMF 120 may support positioning of the UE 105 when the UE 105 accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120).

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then retum the location response (e.g., containing the location estimate) to the external client 130. The GMLC 125 is shown connected to both the AMF 115 and LMF 120, though one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355 or TS 37.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NA S) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), UE Receive-minus-Transmit Time Difference (Rx-Tx Time Difference), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, Rx-Tx Time Difference, RSRP, RSRQ or Time Of Arrival (TOA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP. RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM. WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

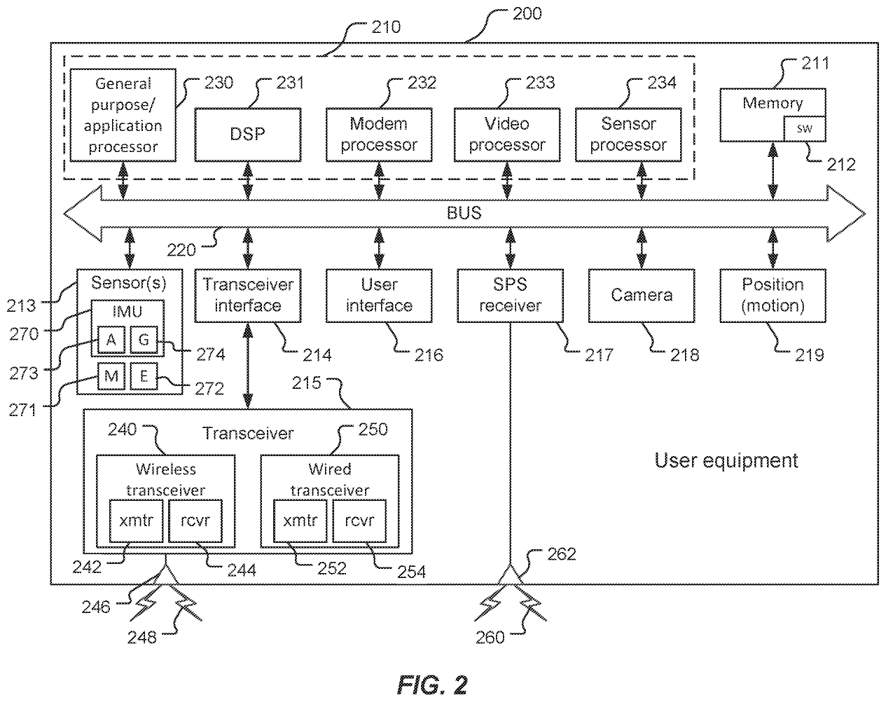

Referring also to FIG. 2, a UE 200 is an example of the UE 105 and comprises a computing platform including a processor 210, memory 211 including software (SW) 212, one or more sensors 213, a transceiver interface 214 for a transceiver 215 (that includes a wireless transceiver and a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radio frequency (RF) sensing (with one or more wireless signals transmitted and reflection(s) used to identify, map and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access). WCDMA (Wideband CDMA), LTE (Long-Term Evolution), LTE Direct (LTE-D), 3GPP LTE-V2X (PC5), V2C (Uu), IEEE 802.11 (including IEEE 802.11p), WiFi, WiFi Direct (WiFi-D), Bluetooth®, Zigbee etc. NR systems may be configured to operate on different frequency layers such as FR1 (e.g., 410-7125 MHz) and FR2 (e.g., 24.25-52.6 GHz), and may extend into new bands such as sub-6 GHz and/or 100 GHz and higher (e.g., FR2x, FR3, FR4). The wired transceiver 250 may include a transmitter 252 and a receiver 254 configured for wired communication, e.g., with the network 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

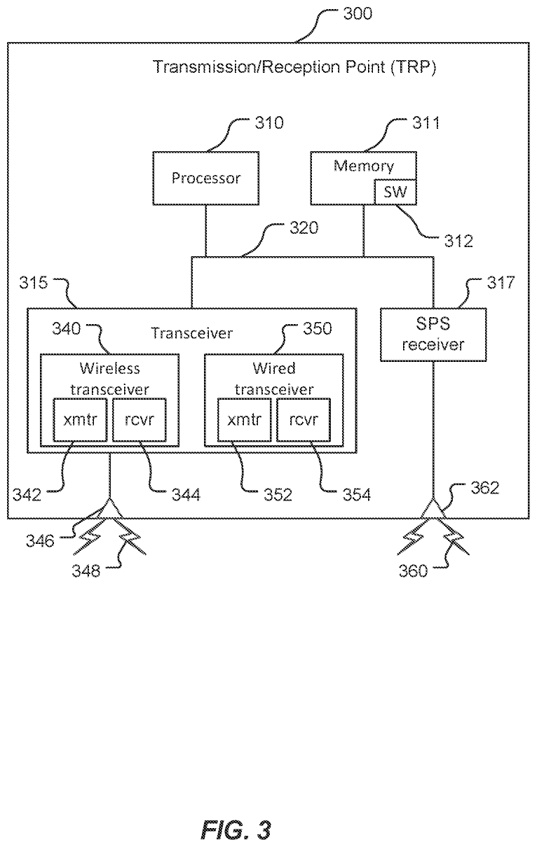

Referring also to FIG. 3, an example of a TRP 300 of the BSs 110a, 110b, 114 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels) and/or receiving (e.g., on one or more downlink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120 or other network server, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

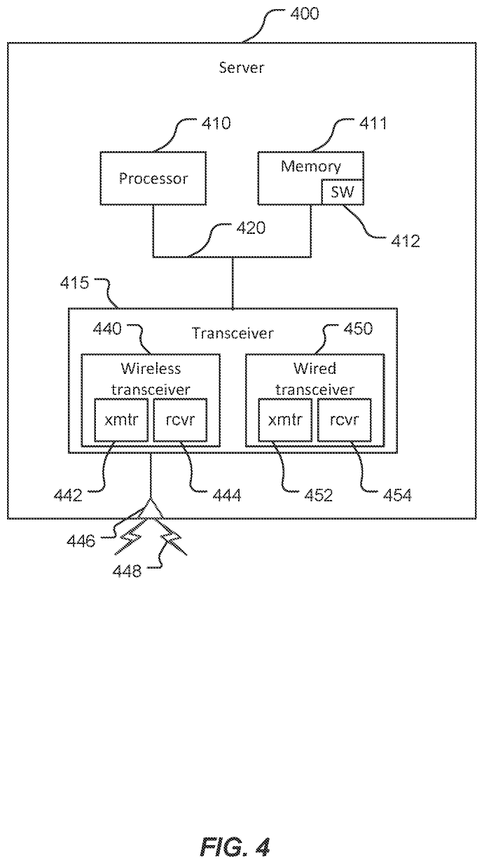

Referring also to FIG. 4, an example server, such as the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices. e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System). CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetoothl, Zigbee etc. The wired transceiver 450 may include a transmitter 452 and a receiver 454 configured for wired communication, e.g., with the network 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

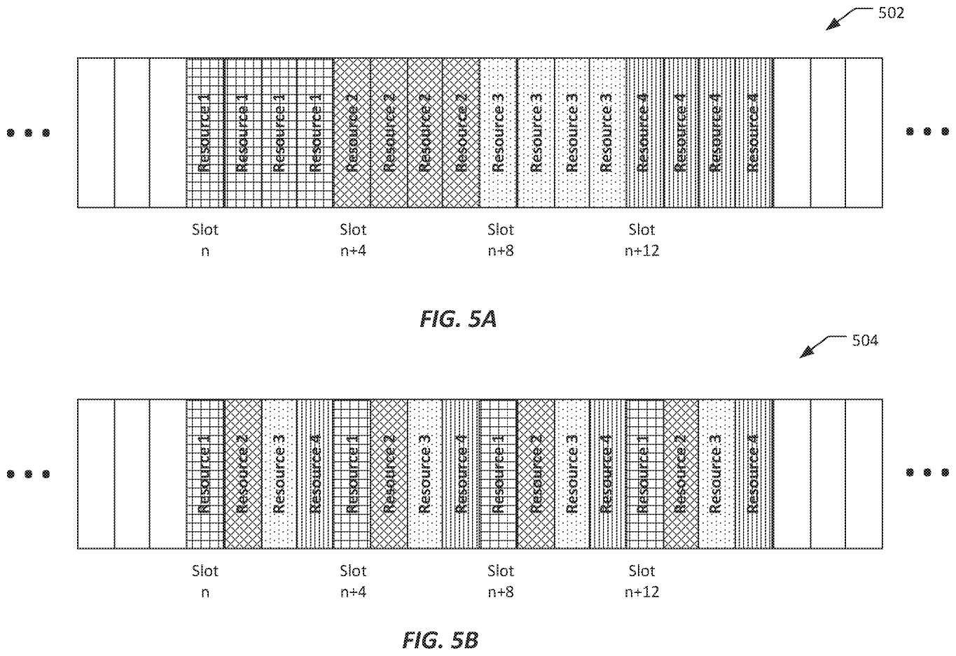

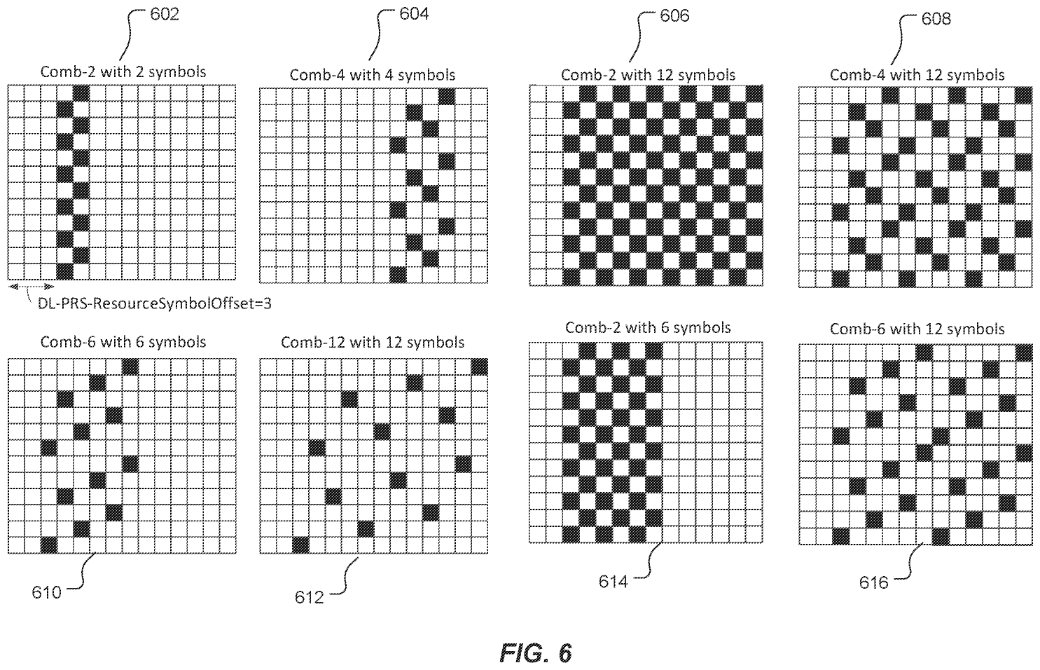

Referring to FIGS. 5A and 5B, example downlink PRS resource sets are shown. In general, a PRS resource set is a collection of PRS resources across one base station (e.g., TRP 300) which have the same periodicity, a common muting pattern configuration and the same repetition factor across slots. A first PRS resource set 502 includes 4 resources and a repetition factor of 4, with a time-gap equal to 1 slot. A second PRS resource set 504 includes 4 resources and a repetition factor of 4 with a time-gap equal to 4 slots. The repetition factor indicates the number of times each PRS resource is repeated in each single instance of the PRS resource set (e.g., values of 1, 2, 4, 6, 8, 16, 32). The time-gap represents the offset in units of slots between two repeated instances of a PRS resource corresponding to the same PRS resource ID within a single instance of the PRS resource set (e.g., values of 1, 2, 4, 8, 16, 32). The time duration spanned by one PRS resource set containing repeated PRS resources does not exceed PRS-periodicity. The repetition of a PRS resource enables receiver beam sweeping across repetitions and combining RF gains to increase coverage. The repetition may also enable intra-instance muting.

Referring to FIG. 6, example subframe and slot formats for positioning reference signal transmissions are shown. The example subframe and slot formats are included in the PRS resource sets depicted in FIGS. 5A and 5B. The subframes and slot formats in FIG. 6 are examples and not limitations and include a comb-2 with 2 symbols format 602, a comb-4 with 4 symbols format 604, a comb-2 with 12 symbols format 606, a comb-4 with 12 symbols format 608, a comb-6 with 6 symbols format 610, a comb-12 with 12 symbols format 612, a comb-2 with 6 symbols format 614, and a comb-6 with 12 symbols format 616. In general, a subframe may include 14 symbol periods with indices 0 to 13. The subframe and slot formats may be used for a Physical Broadcast Channel (PBCH). Typically, a base station may transmit the PRS from antenna port 6 on one or more slots in each subframe configured for PRS transmission. The base station may avoid transmitting the PRS on resource elements allocated to the PBCH, a primary synchronization signal (PSS), or a secondary synchronization signal (SSS) regardless of their antenna ports. The cell may generate reference symbols for the PRS based on a cell ID, a symbol period index, and a slot index. Generally, a UE may be able to distinguish the PRS from different cells.

A base station may transmit the PRS over a particular PRS bandwidth, which may be configured by higher layers. The base station may transmit the PRS on subcarriers spaced apart across the PRS bandwidth. The base station may also transmit the PRS based on the parameters such as PRS periodicity TPRS, subframe offset PRS, and PRS duration NPRS. PRS periodicity is the periodicity at which the PRS is transmitted. The PRS periodicity may be, for example, 160, 320, 640 or 1280 ms. Subframe offset indicates specific subframes in which the PRS is transmitted. And PRS duration indicates the number of consecutive subframes in which the PRS is transmitted in each period of PRS transmission (PRS occasion). The PRS duration may be, for example, 1, 2, 4 or 6 ms.

The PRS periodicity TPRS and the subframe offset PRS may be conveyed via a PRS configuration index IPRS. The PRS configuration index and the PRS duration may be configured independently by higher layers. A set of NPRS consecutive subframes in which the PRS is transmitted may be referred to as a PRS occasion. Each PRS occasion may be enabled or muted, for example, the UE may apply a muting bit to each cell. A PRS resource set is a collection of PRS resources across a base station which have the same periodicity, a common muting pattern configuration, and the same repetition factor across slots (e.g., 1, 2, 4, 6, 8, 16, 32 slots).

In general, the PRS resources depicted in FIGS. 5A and 5B may be a collection of resource elements that are used for transmission of PRS. The collection of resource elements can span multiple physical resource blocks (PRBs) in the frequency domain and N (e.g., 1 or more) consecutive symbol(s) within a slot in the time domain. In a given OFDM symbol, a PRS resource occupies consecutive PRBs. A PRS resource is described by at least the following parameters: PRS resource identifier (ID), sequence ID, comb size-N, resource element offset in the frequency domain, starting slot and starting symbol, number of symbols per PRS resource (i.e., the duration of the PRS resource), and QCL information (e.g., QCL with other DL reference signals). Currently, one antenna port is supported. The comb size indicates the number of subcarriers in each symbol carrying PRS. For example, a comb-size of comb-4 means that every fourth subcarrier of a given symbol carries PRS.

A PRS resource set is a set of PRS resources used for the transmission of PRS signals, where each PRS resource has a PRS resource ID. In addition, the PRS resources in a PRS resource set are associated with the same transmission-reception point (e.g., a TRP 300). Each of the PRS resources in the PRS resource set have the same periodicity, a common muting pattern, and the same repetition factor across slots. A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. Note that this does not have any implications on whether the base stations and the beams on which PRS are transmitted are known to the UE.

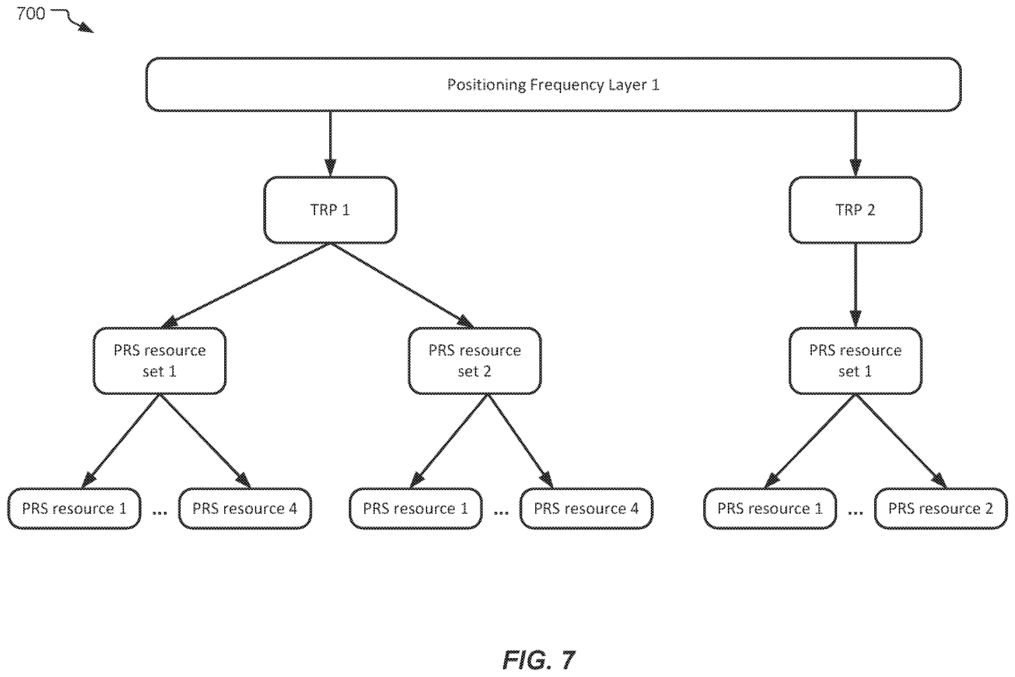

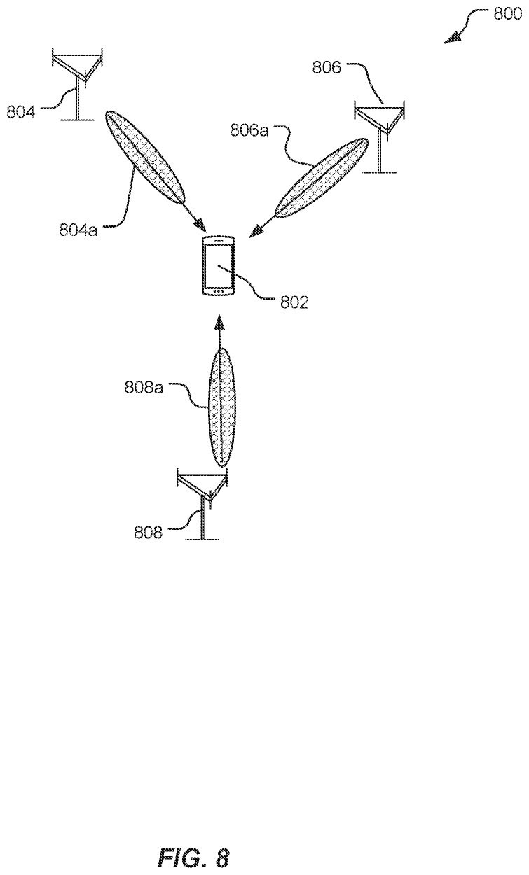

Referring to FIG. 7, a diagram of an example positioning frequency layer 700 is shown. In an example, the positioning frequency layer 700 may be a collection of PRS resource sets across one or more TRPs. The positioning frequency layer may have the same subcarrier spacing (SCS) and cyclic prefix (CP) type, the same point-A, the same value of DL PRS Bandwidth, the same start PRB, and the same value of comb-size. The numerologies supported for PDSCH may be supported for PRS. Each of the PRS resource sets in the positioning frequency layer 700 is a collection of PRS resources across one TRP which have the same periodicity, a common muting pattern configuration, and the same repetition factor across slots.

Note that the terms positioning reference signal and PRS are reference signals that can be used for positioning, such as but not limited to, PRS signals, navigation reference signals (NRS) in 5G, downlink position reference signals (DL-PRS), uplink position reference signals (UL-PRS), tracking reference signals (TRS), cell-specific reference signals (CRS), channel state information reference signals (CSI-RS), primary synchronization signals (PSS), secondary synchronization signals (SSS), sounding reference signals (SRS), etc.

The ability of a UE to process PRS signals may vary based on the capabilities of the UE. In general, however, industry standards may be developed to establish a common PRS capability for UEs in a network. For example, an industry standard may require that a duration of DL PRS symbol in units of milliseconds (ms) a UE can process every T ms assuming a maximum DL PRS bandwidth in MHz, which is supported and reported by UE. As examples, and not limitations, the maximum DL PRS bandwidth for the FR1 bands may be 5, 10, 20, 40, 50, 80, 100 MHz, and for the FR2 bands may be 50, 1X), 200, 400 MHz. The standards may also indicate a DL PRS buffering capability as a Type 1 (i.e., sub-slot/symbol level buffering), or a Type 2 (i.e., slot level buffering). The common UE capabilities may indicate a duration of DL PRS symbols N in units of ms a UE can process every T ms assuming maximum DL PRS bandwidth in MHz, which is supported and reported by a UE. Example T values may include 8, 16, 20, 30, 40, 80, 160, 320, 640, 1280 ms, and example N values may include 0.125, 0.25, 0.5, 1, 2, 4, 6, 8, 12, 16, 20, 25, 30, 32, 35, 40, 45, 50 ms. A UE may be configured to report a combination of (N, T) values per band, where N is a duration of DL PRS symbols in ms processed every T ms for a given maximum bandwidth (B) in MHz supported by a UE. In general, a UE may not be expected to support a DL PRS bandwidth that exceeds the reported DL PRS bandwidth value. The UE DL PRS processing capability may be defined for a single positioning frequency layer 700. The UE DL PRS processing capability may be agnostic to DL PRS comb factor configurations such as depicted in FIG. 6. The UE processing capability may indicate a maximum number of DL PRS resources that a UE can process in a slot under it. For example, the maximum number for FR1 bands may be 1, 2, 4, 6, 8, 12, 16, 24, 32, 48, 64 for each SCS: 15 kHz, 30 kHz, 60 kHz, and the maximum number for the FR2 bands may be 1, 2, 4, 6, 8, 12, 16, 24, 32, 48, 64 for each SCS: 15 kHz, 30 kHz, 60 kHz, 120 kHz.

Referring to FIG. 8, a diagram 800 of downlink positioning reference signals is shown. The diagram 800 includes a UE 802 and a plurality of base stations including a first base station 804, a second base station 806, and a third base station 808. The UE 802 may have some or all of the components of the UE 200, and the UE 200 may be an example of the UE 802. Each of the base stations 804, 806, 808 may have some or all of the components of the TRP 300, and the TRP 300 may be an example of one or more of the base stations 804, 806, 808. In operation, the UE 802 may be configured to receive one or more reference signals such as a first reference signal 804a, a second reference signal 806a, and a third reference signal 808a. The reference signals 804a, 806a, 808a may be DL PRS or other positioning signals which may be received/measured by the UE 802. While the diagram 800 depicts three reference signals, fewer or more reference signals may be transmitted by the base stations and detected by the UE 802. In general, DL PRS signals in NR may be configured reference signals transmitted by the base stations 804, 806, 808 and used for the purpose of determining respective ranges between the UE 802 and the transmitting base stations. The UE 802 may also be configured to transmit uplink PRS (UL PRS, SRS for positioning) to the base stations 804, 806, 808, and the base stations may be configured to measure the UL PRS and report the corresponding measurement values to a location server (e.g., the LMF 120) to determine a position estimate for the UE 802.

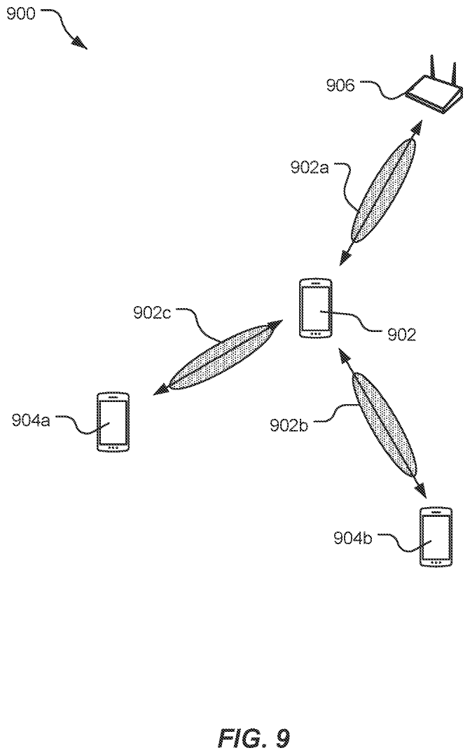

Referring to FIG. 9, a diagram 900 of sidelink positioning reference signals is shown. The diagram 900 includes a target UE 902 and a plurality of neighboring stations including a first neighbor UE 904a, a second neighbor UE 904b, and a third neighbor station 906. Each of the target UE 902 and the neighbor UEs 904a-b may have some or all of the components of the UE 200, and the UE 200 may be an example of the target UE 902 and the neighbor UEs 904a-b. The station 906 may have some or all of the components of the TRP 300, and the TRP 300 may be an example of the station 906. In an embodiment, the station 906 may be a roadside unit (RSU) in a V2X network. In operation, the target UE 902 may be configured to transmit or receive one or more sidelink reference signals 902a-c via a sidelink channel such as the Physical Sidelink Shared Channel (PSSCH), the Physical Sidelink Control Channel (PSCCH), the Physical Sidelink Broadcast Channel (PSBCH), and/or other sidelink channels and D2D interfaces. In an example, the reference signals may utilize a D2D interface such as the PC5 interface. The reference signals 902a-c may be UL PRS (SRS for positioning signals) and/or SL-PRS, and may be transmitted or received by one or more of the neighboring UEs 904a-b, or the station 906. While the diagram 900 depicts three reference signals, few or more reference signals may be received or transmitted by the target UE 902 and transmitted or received, respectively, by one or more neighboring UEs and stations. In an embodiment, the sidelink reference signals 902a-c may be SRS for positioning resources and may be included in a SRS for positioning resource set.

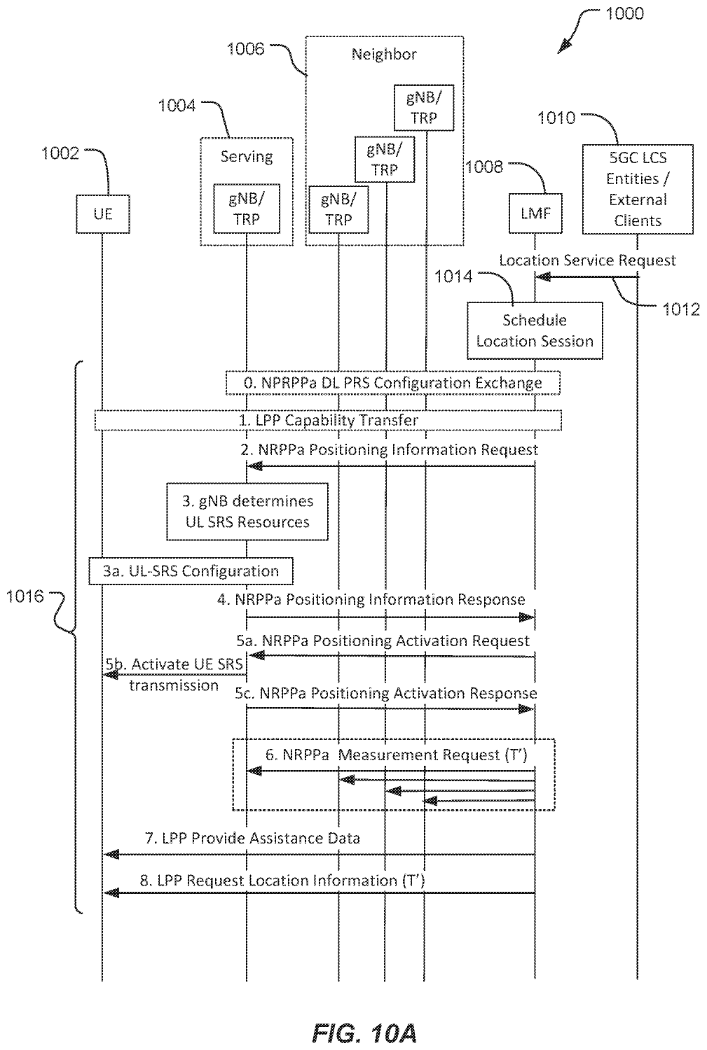

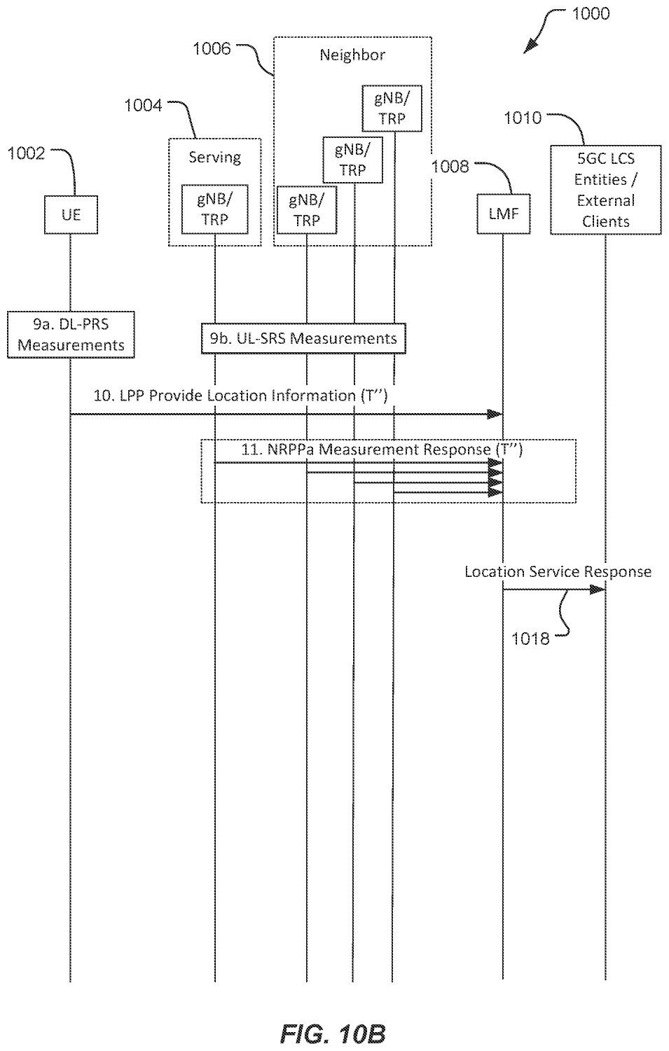

Referring to FIGS. 10A and 10B, an example message flow 1000 for obtaining location information in a time window is shown. The flow 1000 is an example only, as stages may be added, rearranged, and/or removed. The message flow 1000 may include a target UE 1002, a serving station 1004, a plurality of neighboring stations 1006, a server 1008, and one or more LCS entities and/or extremal clients 1010. The UE 200 may be an example of the target UE 1002, a TRP 300 such as the gNB 110a may be an example of the serving station 1004, and a server 400 such as the LMF 120 may be an example of the server 1008. The plurality of neighboring stations 1006 may include base stations such as the gNB 110b, the eNB 114, or other stations such as neighboring UEs (e.g., configured for sidelink or other D2D communications). In an embodiment, the LCS server 1010, or other extemal client, may provide a location service request 1012 to the server 1008 indicating a time in the future (e.g., a time ‘T’) to obtain the location of the target UE 1002. In an example, the location service request 1012 may also include one or more parameters to define a time window in which to obtain the location of the target UE 1002 (e.g., a delta time (A) value). At stage 1014, the server 1008 is configured to schedule a location procedure such that the location of the target UE 1002 may be obtained at the request time ‘T.’ A positioning preparation phase 1016 may start at a time equal to T−t1, where t1 depends on the expected duration of the positioning preparation phase 1016. The value of t1 may vary based on a selected positioning method and other operational constraints associated with a communication network. At step 0, the server 1008 may send and receive PRS configuration information to and from a plurality of network nodes including the serving station 1004 and the neighboring stations 1006. At step 1, the server 1008 may request positioning capabilities from the target UE 1002 via one or more LPP messages. At step 2, the server 1008 may request UL-SRS configuration information for the target UE 1002 from the serving station 1004. The server 1008 may provide assistance data to the serving station 1004 including reference signal transmission properties such as a pathloss reference, spatial relation information, Synchronization Signal Block (SSB) configuration information, or other information required by the serving station 1004 to determine a range to the target UE 1002. At step 3, the serving station 1004 is configured to determine the resources available for UL-SRS and configured the target UE 1002 with the UL-SRS resource sets. At step 3a., the serving station 1004 may provide the UL-PRS configuration parameters to the target UE 1002 in one or more Radio Resource Control (RRC) messages. At step 4, the serving station 1004 provides the UL-PRS configuration parameters to the server 1008.

At step 5a, the server 1008 may send a NRPPa Positioning Activation Request message to the serving station 1004 to request activation of the UL-PRS in the target UE 1002 according to one or more configurations provided to the target UE 1002 at step 3a. At step 5b, the serving station 1004 may send an activation signal, such as a MAC Control Element, to the target UE 1002 to activate the UL-PRS as requested at step 5a. If a start time was provided at step 5a, the serving station 1004 may send this command at the requested start time. At step 5c, if the UL-PRS has been successfully activated, the serving station 1004 may retum a NRPPa Positioning Activation Response message to the server 1008. If the requested start time provided at step 5c cannot be fulfilled, the serving station 1004 may determine a different start time and provide the selected start time to the server 1008. At step 6, the server 1008 may send a NRPPa Measurement Request message to the serving station 1004 and neighbor stations 1006 to request UL-PRS measurements at a physical time T′ (e.g., gNB Rx-Tx Time Difference Measurements). The time T′ may define a time when the target UE 1002 location is obtained. In an example, T′ may specify a SFN/slot. T′ may have a 1:1 relation to the time T (e.g., a 1:1 relation to UTC). At step 7, the server 1008 may provide assistance data to the target UE 1002 in a LPP assistance data message. At step 8, the server 1008 sends a LPP request location information message indicating the time T′ when the location measurements are to be obtained.

Referring to FIG. 10B, at step 9a, the target UE 1002 acquires and measures the DL-PRS transmitted by the serving stations 1004 and neighboring stations 1006, and at step 9b the stations 1004, 1006 which received the measurement request at step 6, may acquire and measure the UL-PRS transmitted by the target UE 1002. The target UE 1002 and the stations 1004, 1006 perform the measurements such that the measurements/location is valid at time T′ (i.e., the physical time base corresponding to time T). At step 10, the target UE 1002 provides the DL-PRS measurement information/location estimate to the server 1008 in a LPP Provide Location Information message with a timestamp of time T″, where time T″ is close to the requested time T′. Ideally, time T″ is equal to time T′. The stations 1004, 1006 provide NRPPa Measurement Report messages based on the UL-PRS measurements to the server 1008 with a timestamp of T″. At stage 1018, the server 1008 is configured to provide the location estimate for the target UE 1002 at time T to the LCS entity 1010. In operation, the location estimate may also include some latency or error time values based on the network configuration.

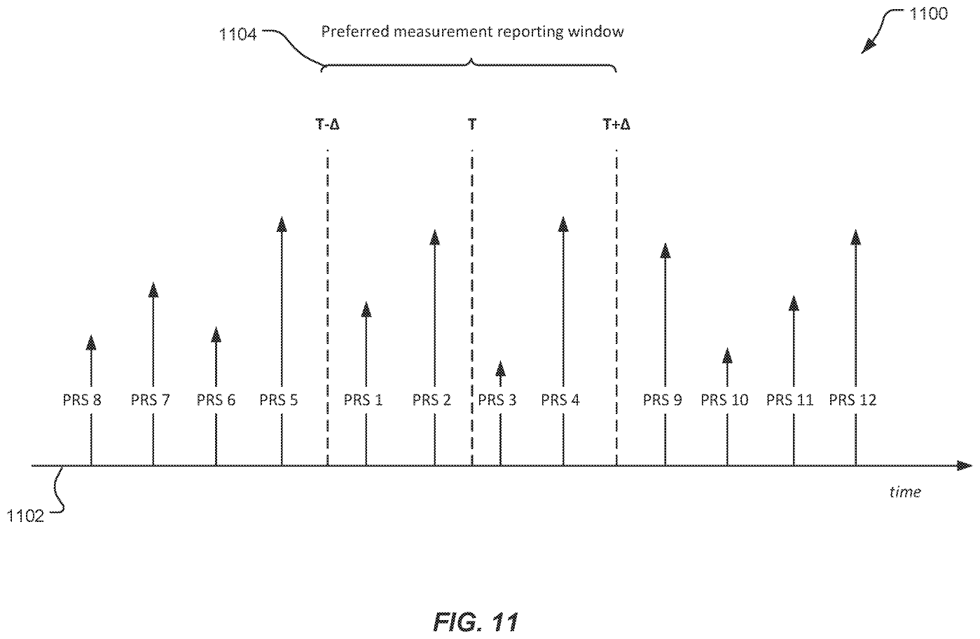

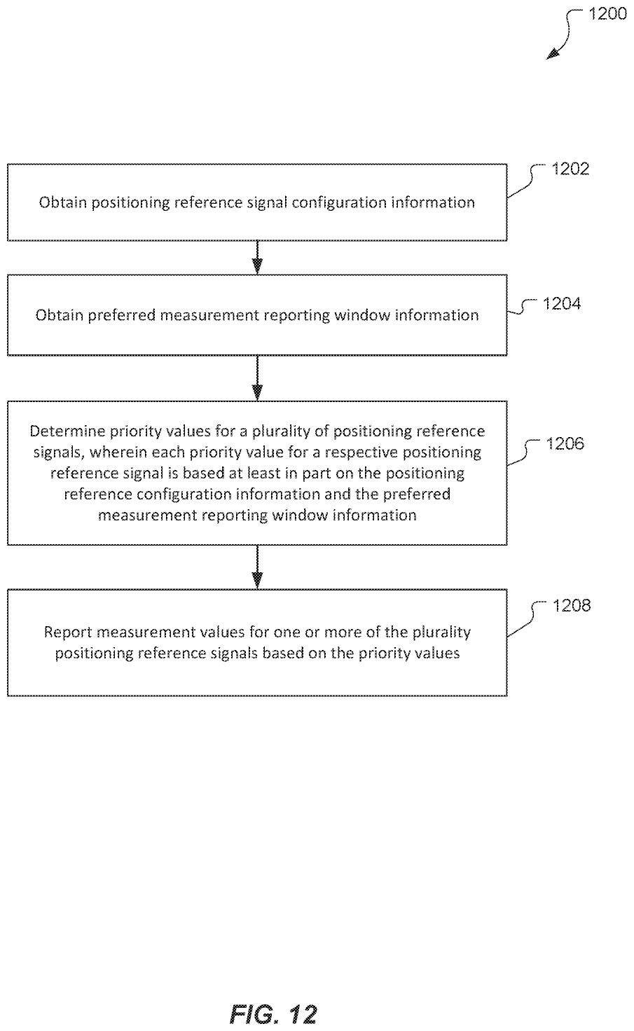

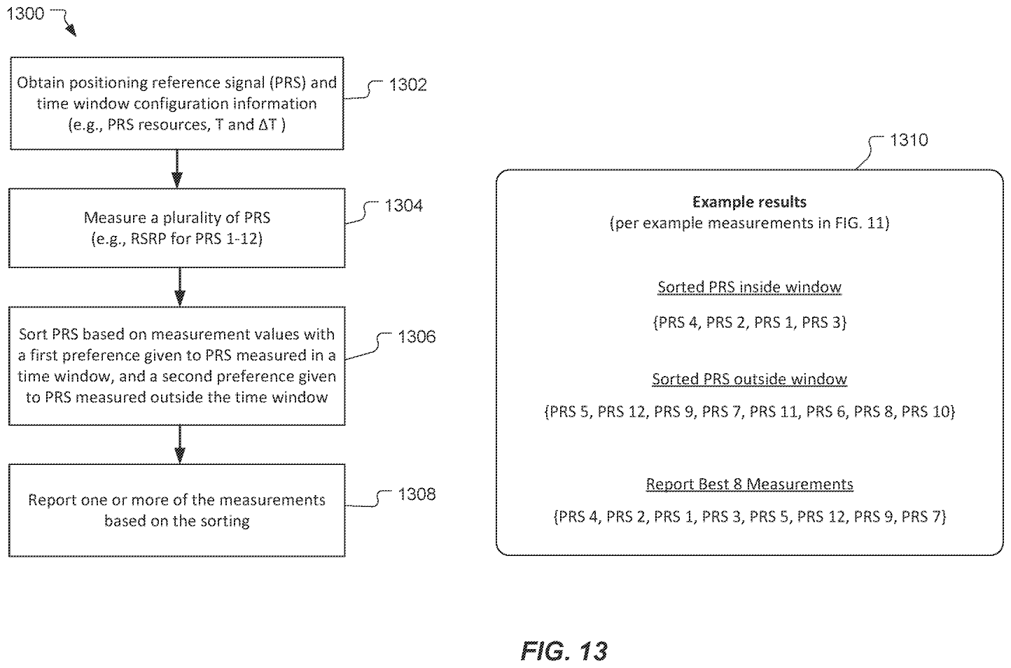

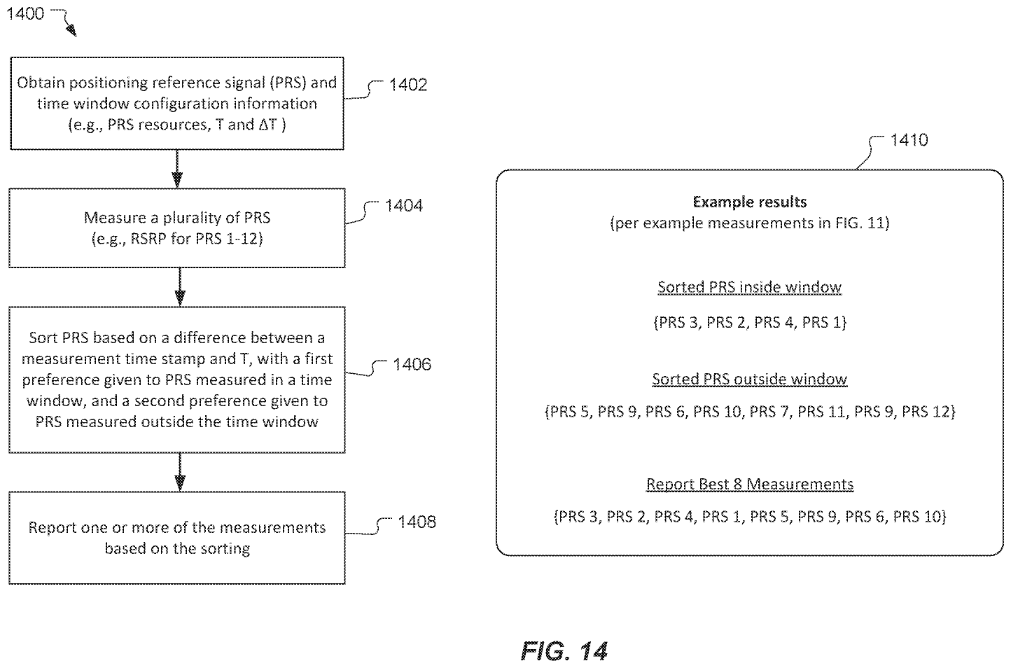

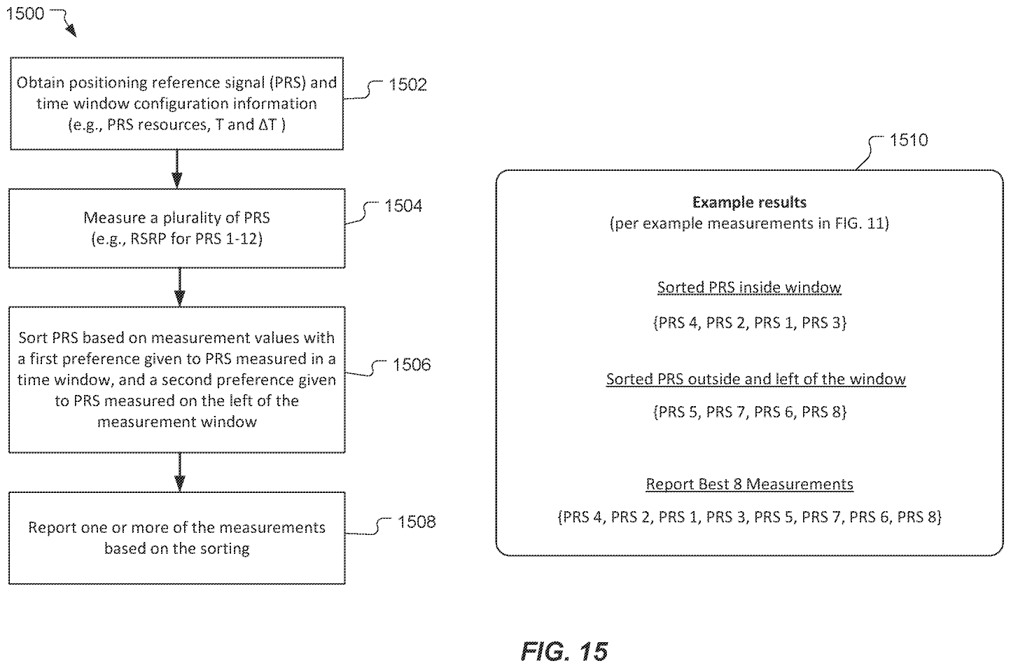

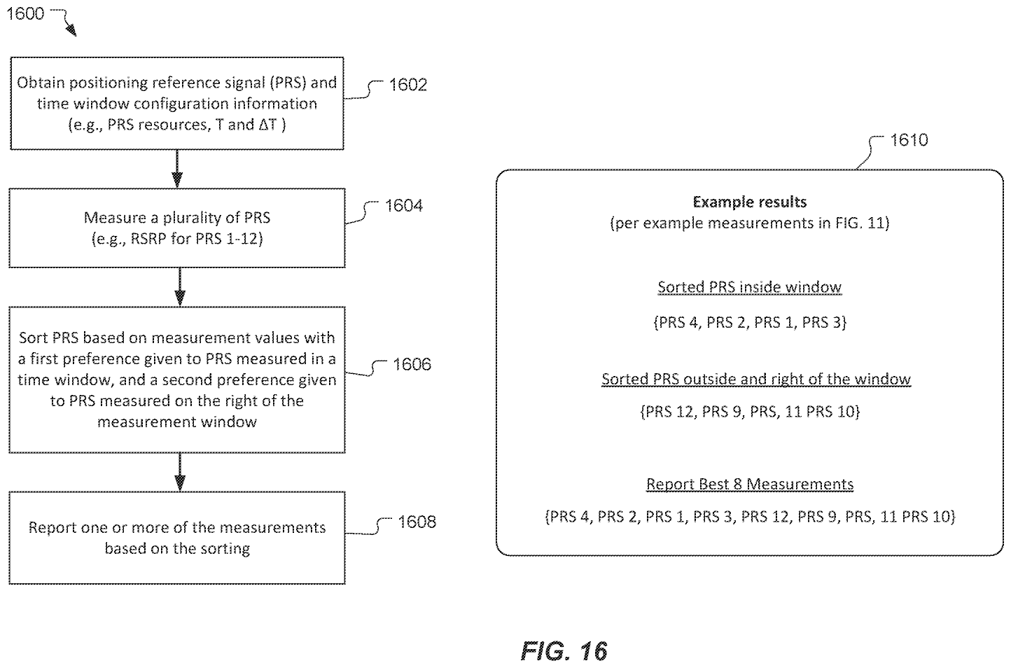

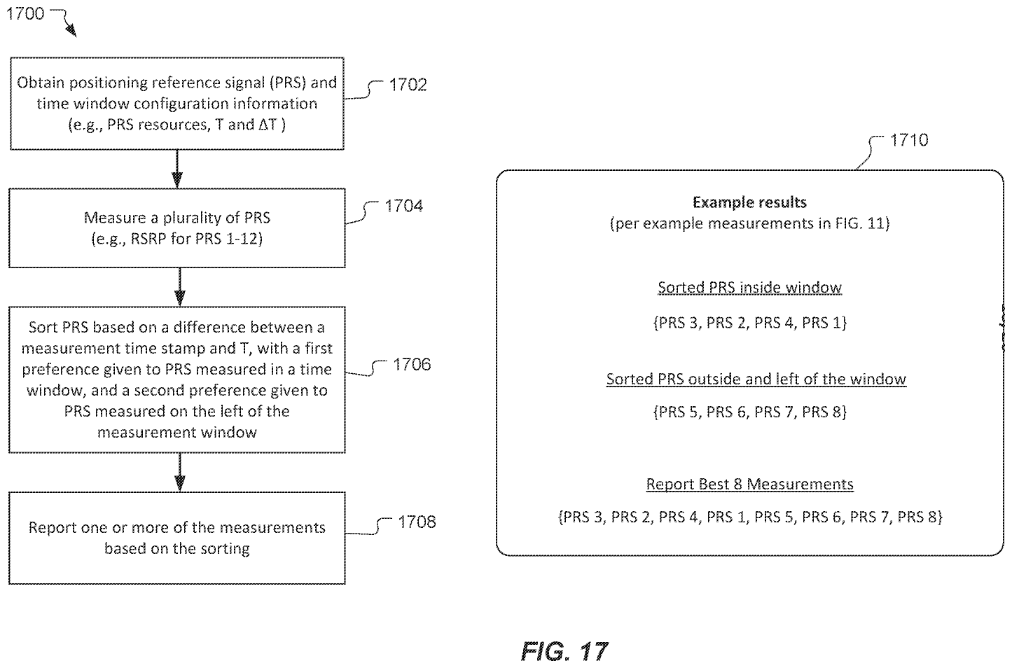

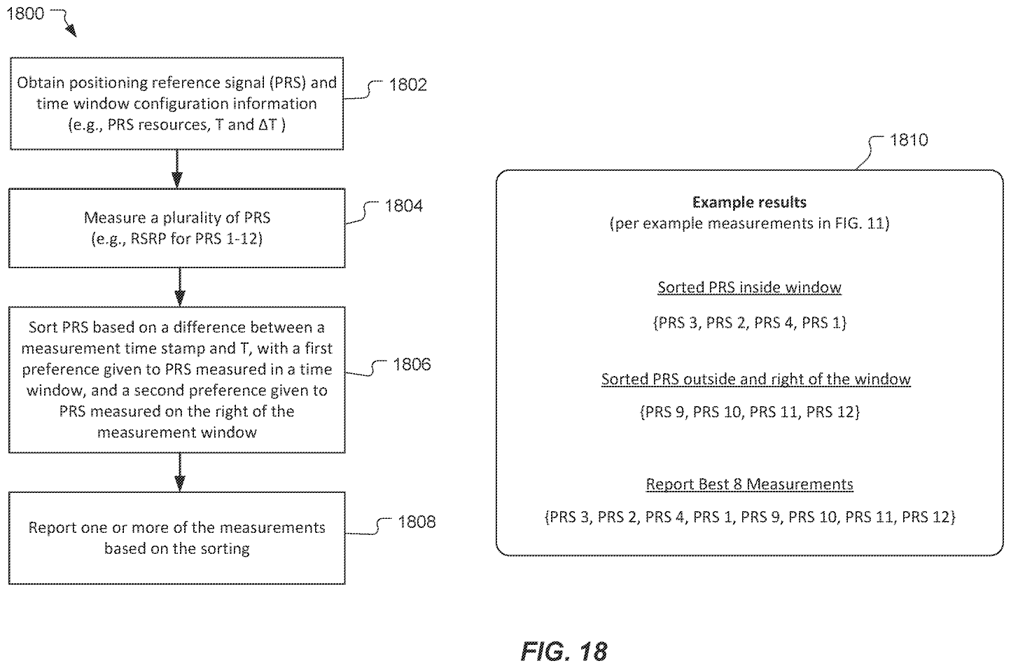

Referring to FIG. 11, a diagram 1100 of positioning reference signals obtained relative to a time window is shown. The diagram 1100 includes a time domain axis 1102 indicating relative positions of 12 PRS measurements (e.g., PRS 1-PRS 12). The height of each of the PRS measurements represents a relative value based on a signal measurement. The measurement values may be based on RSRP, RSTD, UE Tx-TX, LOS/NLOS indications, etc, associated with each PRS. A preferred measurement reporting window 1104 may be based on a scheduled in advance measurement window, such as provided in the location service request 1012. In an example, the preferred measurement reporting window 1104 may be based on a time value T and a delta (A) value received from a network entity, such as the LMF 120 and/or an extemal client 130 (e.g., a LCS entity). Other parameters may also be used to define the preferred measurement reporting window 1104. In an example, a UE 200 is asked to report 8 PRS resource measurement to determine a location at time T. The UE 200 has the 12 PRS measurements depicted in the diagram 1100 available, such that 4 PRS measurements (e.g., PRS 1-4) are inside the preferred measurement reporting window 1104, 4 PRS measurements (e.g., PRS 5-8) are left of the preferred measurement reporting window 1104, and 4 PRS measurements (e.g., PRS 9-12) are right of the preferred measurement reporting window 1104. The techniques provided herein provide different options for the UE 200 to choose PRS resources for measurement reporting.

Referring to FIG. 12, with further reference to FIGS. 1-11, a method 1200 for measuring positioning reference signals based on priority values includes the stages shown. The method 1200 is, however, an example only and not limiting. The method 1200 may be altered, e.g., by having stages added, removed, rearranged, combined, performed concurrently, and/or having single stages split into multiple stages.

At stage 1202, the method includes obtaining positioning reference signal configuration information. A UE 200, including the processor 230 and the transceiver 215, are a means for obtaining positioning reference signal configuration information. In an embodiment, referring to the message flow 1000, a network server 1008, such as the LMF 120, may provide one or more messages or signals such as the LPP capability transfer message and/or LPP Provide Assistance Data messages including PRS configuration information. PRS configuration information may be provided via RRC signaling (e.g., system information blocks (SIBs)). In an example, the PRS configuration information may be associated with PRS resources and/or PRS resource sets as described in FIG. 7. The PRS configuration information may include scheduling information to enable the UE 200 to determine when DL PRS will be transmitted by neighboring base stations.

At stage 1204, the method includes obtaining preferred measurement reporting window information. The UE 200, including the processor 230 and the transceiver 215, is a means for obtaining the preferred measurement reporting window information. A target UE such as the target UE 1002 in FIGS. 10A and 10B, may receive a signal from the network indicating a time to determine and report position information. For example, a LPP Request Location Information message including the preferred measurement reporting window information may be provided to the target UE 1002 during a positioning preparation phase 1016. In an example, the preferred measurement reporting window information may define a time window based on parameters such as a time T parameter and a delta (A) time parameter (e.g., the preferred measurement reporting window 1104 in FIG. 11). The time window information may include other parameters to define a time period to obtain positioning measurements, such as start and end times, a start time and a duration value, etc.

At stage 1206, the method includes determining priority values for a plurality of positioning reference signals, wherein each priority value for a respective positioning reference signal is based at least in part on the positioning reference configuration information and the preferred measurement reporting window information. The UE 200, including the processor 230 and the transceiver 215, is a means for determining priority values for a plurality of PRS. In an embodiment, referring to FIG. 11, the target UE 1002 may determine the plurality of PRS based on the PRS configuration information received at stage 1202 and the preferred measurement reporting window information received at stage 1204. The priority value for each of the PRS may be based at least in part on the time of the PRS transmission relative to the time value T and the delta value (e.g., T−Δ to T+Δ). In an embodiment, a first preference in priority values may be based on sorting the PRS resource inside the preferred measurement reporting window 1104 and a second preference in priority values may be based on PRS resources outside the preferred measurement reporting window 1104. The PRS may be sorted based on the relative distance in time from the time T (e.g., the PRS that are closer in time are a higher priority), sorted based on relative measurement values (e.g., the PRS with stronger RSRP are a higher priority), and/or on combinations of time distances and measurement values. Other prioritization schemes may also be used. For example, FIGS. 13-18 provide example methods for prioritizing PRS relative to a time window.

At stage 1208, the method includes reporting measurement values for one or more of the plurality of positioning reference signals based on the priority values. The UE 200, including the processor 230 and the transceiver 215, is a means for reporting the measurement values. In an embodiment, the target UE 1002 may measure DL-PRS transmissions at step 9a in the message flow 1000 based on the capabilities of the UE. For example, a Reduced Capability (RedCap) UE may have limited bandwidth capabilities and may only be capable of measuring a few (e.g., 2, 3, 4) PRS. Other UEs may have the ability to measure more PRS (e.g., increased processing capabilities, bandwidth, multi-band capabilities). The measurement values may include RSRP, RSTD, Rx-Tx, LOS/NLOS indications, and/or other reference signal measurements. The selection of the PRS to measure may be based on the time window information such that PRS within the time window are given preference to the PRS outside the time window. Other options for prioritizing the measurements may also be used (e.g., as described FIGS. 13-18). The target UE 1002 may report the PRS measurement values to the server 1008 (e.g., the LMF 120) via one or more LPP provide location information messages at step 10 in the message flow 1000. In an embodiment, other over-the-air (OTH) signaling protocols, such as RRC, MAC-CE, DCI, may be used to report the measurement values.

While the examples described above utilize DL-PRS, the method 1200 is not so limited. The method 1200 may be utilized with other reference signals such as UL-PRS (SRS for positioning) and SL-PRS. For example, a target UE may prioritize SL-PRS transmitted from a plurality of stations based on the preferred measurement reporting window information. For example, referring to FIG. 9, the UE 902 may be configured to receive the preferred measurement reporting window information from the station 906 (e.g., an RSU) and SL-PRS from one or more proximate nodes such as the neighboring UEs 904a, 904b. The UE 902 may be configured to measure the SL-PRS and report the corresponding measurement values using the method 1200.

Referring to FIGS. 13-18, with further reference to FIG. 11, example methods for reporting positioning reference signal measurements based on receive times relative to a time window are shown. Each of the methods includes example results based on the PRS depicted in FIG. 11. The capabilities of the UE and the corresponding reporting results are examples and not limitations as other devices may have other processing and reporting capabilities, and other PRS may be received relative to a time window. Further, other wireless nodes such as a TRP 300, may be configured to prioritize and report reference signal measurements as described in FIGS. 13-18.

FIG. 13 includes a first example method 1300 for prioritizing and reporting PRS measurements relative to the preferred measurement reporting window 1104. At stage 1302, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). At stage 1304, the method includes measuring a plurality of PRS. The PRS measurements may include RSRP, RSTD, Rx-Tx, LOS/NLOS indications, and/or other reference signal measurement values. In an example, referring to FIG. 11, measurements such as RSRP may have a magnitude component and may be compared to one another.

At stage 1306, the method includes sorting PRS based on measurement values with a first preference given to PRS measured in a time window, and a second preference given to PRS measured outside the time window. For example, the PRS within the preferred measurement reporting window 1104 (e.g., PRS 1-4) may be sorted and prioritized based on the magnitude of their respective RSRP values. Thus, as indicated in the method example results object 1310, the sorted PRS inside the preferred measurement reporting window 1104 would be {PRS 4, PRS 2, PRS 1, PRS 3} (i.e., from largest magnitude to smallest magnitude). Similarly, the PRS outside of the preferred measurement reporting window 1104 may also be sorted based on magnitudes of the RSRP values from largest to smallest. In this case, the PRS measured outside the time window would be {PRS 5, PRS 12, PRS 9, PRS 7, PRS 11, PRS 6, PRS 8, PRS 10}. At stage 1308, the method includes reporting one or more of the measurements based on the sorting. The number of PRS measurement values reported may be based on the capabilities of the measuring device (e.g., a UE) and the network requirements (e.g., bandwidth, position accuracy, etc.). In an example, the UE may be configured to report the best 8 measurements based on the sorting performed at stage 1306. Priority is given to the PRS measured within the time window such that the 8 best measurements would include {PRS 4, PRS 2, PRS 1, PRS 3, PRS 5, PRS 12, PRS 9, PRS 7}.

FIG. 14 includes a second example method 1400 for prioritizing and reporting PRS measurements relative to the preferred measurement reporting window 1104. At stage 1402, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). The time window information may include other parameters to define a duration of time, such as start and end times, a start time and a duration value, etc. At stage 1404, the method includes measuring a plurality of PRS. The PRS measurements may include RSRP, RSTD, Rx-Tx, LOS/NLOS indications, and/or other reference signal measurement values.

At stage 1406, the method includes sorting PRS based on a difference between a measurement time stamp and T, with a first preference given to PRS measured in a time window, and a second preference given to PRS measured outside the time window. For example, the PRS within the preferred measurement reporting window 1104 (e.g., PRS 1-4) may be sorted and prioritized based on the distance from the time value T. Thus, as indicated in the method example results object 1410, the sorted PRS inside the preferred measurement reporting window 1104 would be {PRS 3, PRS 2, PRS 4, PRS 1} (i.e., from closest in time to the furthest in time). Similarly, the PRS outside of the preferred measurement reporting window 1104 may also be sorted based on distance from the time value T. In this case, the PRS measured outside the time window would be {PRS 5, PRS 9, PRS 6, PRS 10. PRS 7, PRS 11, PRS 9, PRS 12}. At stage 1408, the method includes reporting one or more of the measurements based on the sorting. The number of PRS measurement values reported may be based on the capabilities of the measuring device (e.g., UE) and the network requirements (e.g., bandwidth, position accuracy, etc.). In an example, the UE may be configured to report the best 8 measurements based on the sorting performed at stage 1406. Priority is given to the PRS measured within the time window such that the 8 best measurements would include {PRS 3, PRS 2, PRS 4, PRS 1, PRS 5, PRS 9, PRS 6, PRS 10}.

FIG. 15 includes a third example method 1500 for prioritizing and reporting PRS measurements relative to the preferred measurement reporting window 1104. At stage 1502, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). At stage 1504, the method includes measuring a plurality of PRS. The PRS measurements may include RSRP, RSTD, Rx-Tx, LOS/NLOS indications, and/or other reference signal measurement values. In an example, referring to FIG. 11, measurements such as RSRP may have a magnitude component and may be compared to one another.

At stage 1506, the method includes sorting PRS based on measurement values with a first preference given to PRS measured in a time window, and a second preference given to PRS measured on the left of the measurement window. For example, the PRS within the preferred measurement reporting window 1104 (e.g., PRS 1-4) may be sorted and prioritized based on the magnitude of their respective RSRP values. Thus, as indicated in the method example results object 1510, the sorted PRS inside the preferred measurement reporting window 1104 would be {PRS 4, PRS 2, PRS 1, PRS 3} (i.e., from largest magnitude to smallest magnitude). Similarly, the PRS outside and to the left of the preferred measurement reporting window 1104 may also be sorted based on magnitudes of the RSRP values from largest to smallest. In this case, the PRS measured outside the time window would be {PRS 5, PRS 7, PRS 6, PRS 8}. At stage 1508, the method includes reporting one or more of the measurements based on the sorting. The number of PRS measurement values reported may be based on the capabilities of the measuring device (e.g., UE) and the network requirements (e.g., bandwidth, position accuracy, etc.). In an example, the UE may be configured to report the best 8 measurements based on the sorting performed at stage 1506. Priority is given to the PRS measured within the time window such that the 8 best measurements would include {PRS 4, PRS 2, PRS 1, PRS 3, PRS 5. PRS 7, PRS 6, PRS 8}.

FIG. 16 includes a fourth example method 1600 for prioritizing and reporting PRS measurements relative to the preferred measurement reporting window 1104. At stage 1602, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). At stage 1604, the method includes measuring a plurality of PRS. The PRS measurements may include RSRP, RSTD, Rx-Tx. LOS/NLOS indications, and/or other reference signal measurement values. In an example, referring to FIG. 11, measurements such as RSRP may have a magnitude component and may be compared to one another.

At stage 1606, the method includes sorting PRS based on measurement values with a first preference given to PRS measured in a time window, and a second preference given to PRS measured on the right of the measurement window. For example, the PRS within the preferred measurement reporting window 1104 (e.g., PRS 1-4) may be sorted and prioritized based on the magnitude of their respective RSRP values. Thus, as indicated in the method example results object 1610, the sorted PRS inside the preferred measurement reporting window 1104 would be {PRS 4, PRS 2, PRS 1, PRS 3} (i.e., from largest magnitude to smallest magnitude). Similarly, the PRS outside and to the right of the preferred measurement reporting window 1104 may also be sorted based on magnitudes of the RSRP values from largest to smallest. In this case, the PRS measured outside the time window would be {PRS 12, PRS 9, PRS, 11 PRS 10}. At stage 1608, the method includes reporting one or more of the measurements based on the sorting. The number of PRS measurement values reported may be based on the capabilities of the measuring device (e.g., UE) and the network requirements (e.g., bandwidth, position accuracy, etc.). In an example, the UE may be configured to report the best 8 measurements based on the sorting performed at stage 1606. Priority is given to the PRS measured within the time window such that the 8 best measurements would include {PRS 4, PRS 2, PRS 1, PRS 3, PRS 12, PRS 9, PRS, 11 PRS 10}.

FIG. 17 includes a fifth example method 1700 for prioritizing and reporting PRS measurements relative to the preferred measurement reporting window 1104. At stage 1702, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). At stage 1704, the method includes measuring a plurality of PRS. The PRS measurements may include RSRP, RSTD, Rx-Tx, LOS/NLOS indications, and/or other reference signal measurement values.

At stage 1706, the method includes sorting PRS based on a difference between a measurement time stamp and T, with a first preference given to PRS measured in a time window, and a second preference given to PRS measured on the left of the measurement window. For example, the PRS within the preferred measurement reporting window 1104 (e.g., PRS 1-4) may be sorted and prioritized based on the distance from the time value T. Thus, as indicated in the method example results object 1710, the sorted PRS inside the preferred measurement reporting window 1104 would be {PRS 3, PRS 2, PRS 4, PRS 1} (i.e., from closest in time to the furthest in time). Similarly, the PRS outside and to the left of the preferred measurement reporting window 1104 may also be sorted based on distance from the time value T. In this case, the PRS measured outside and to the left the time window would be {PRS 5, PRS 6, PRS 7, PRS 8}. At stage 1708, the method includes reporting one or more of the measurements based on the sorting. The number of PRS measurement values reported may be based on the capabilities of the measuring device (e.g., UE) and the network requirements (e.g., bandwidth, position accuracy, etc.). In an example, the UE may be configured to report the best 8 measurements based on the sorting performed at stage 1706. Priority is given to the PRS measured within the time window such that the 8 best measurements would include {PRS 3, PRS 2, PRS 4, PRS 1, PRS 5. PRS 6, PRS 7, PRS 8}.

FIG. 18 includes a sixth example method 1800 for prioritizing and reporting PRS measurements relative to the preferred measurement reporting window 1104. At stage 1802, the method includes obtaining positioning reference signal (PRS) and time window configuration information. In an example, referring to the message flow 1000, a network server 1008, such as the LMF 120, may provide one or more messages or signals such as the LPP capability transfer message and/or LPP Provide Assistance Data messages including PRS configuration information. The LMF 120 may also provide a LPP Request Location Information message including the time window information during a positioning preparation phase 1016. In an example, the time window information may be parameters including a time T parameter and a delta (A) time parameter (e.g., the preferred measurement reporting window 1104). At stage 1804, the method includes measuring a plurality of PRS. The PRS measurements may include RSRP, RSTD, Rx-Tx, LOS/NLOS indications, and/or other reference signal measurement values.

At stage 1806, the method includes sorting PRS based on a difference between a measurement time stamp and T, with a first preference given to PRS measured in a time window, and a second preference given to PRS measured on the right of the measurement window. For example, the PRS within the preferred measurement reporting window 1104 (e.g., PRS 1-4) may be sorted and prioritized based on the distance from the time value T. Thus, as indicated in the method example results object 1810, the sorted PRS inside the preferred measurement reporting window 1104 would be {PRS 3, PRS 2, PRS 4, PRS 1} (i.e., from closest in time to the furthest in time). Similarly, the PRS outside and to the right of the preferred measurement reporting window 1104 may also be sorted based on distance from the time value T. In this case, the PRS measured outside and to the right the time window would be {PRS 9, PRS 10, PRS 11, PRS 12}. At stage 1808, the method includes reporting one or more of the measurements based on the sorting. The number of PRS measurement values reported may be based on the capabilities of the measuring device (e.g., UE) and the network requirements (e.g., bandwidth, position accuracy, etc.). In an example, the UE may be configured to report the best 8 measurements based on the sorting performed at stage 1806. Priority is given to the PRS measured within the time window such that the 8 best measurements would include {PRS 3, PRS 2, PRS 4, PRS 1, PRS 9, PRS 10, PRS 11, PRS 12}.

The prioritization and reporting methods described in FIGS. 13-18 are examples and not limitations as other sorting methods may be used. For example, legacy priority values assigned to a PRS resource by a gNB may be used. In an embodiment, a TRP 300 may be configured to assign priority values to PRS resources based on beam width information and an estimated location of a target UE. The DL PRS resources in a positioning frequency layer may be sorted in a decreasing order of priority for a measurement to be performed by the UE. These legacy priority values may be utilized in conjunction with the preferrcd measurement reporting window 1104 such that the PRS within the preferred measurement reporting window 1104 may be sorted based on the legacy priority value, and the PRS outside of the preferred measurement reporting window 1104 may be sorted based on the legacy priority value, such that the PRS in the preferred measurement reporting window 1104 are preferred as described in FIGS. 13-18.

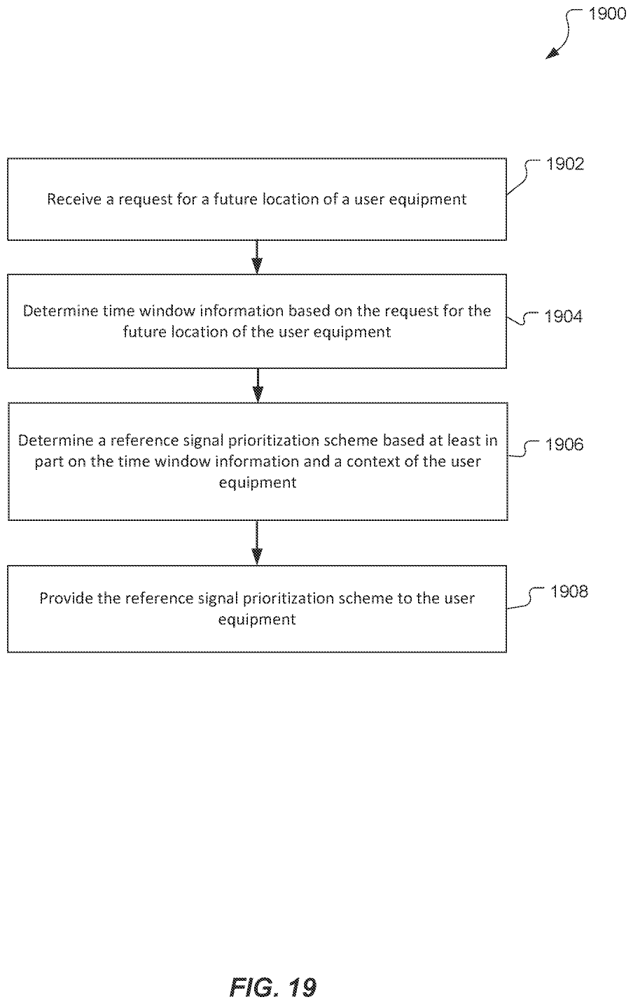

Referring to FIG. 19, with further reference to FIGS. 1-18, a method 1900 for providing a reference signal prioritization scheme to one or more wireless nodes includes the stages shown. The method 1900 is, however, an example only and not limiting. The method 190) may be altered, e.g., by having stages added, removed, rearranged, combined, performed concurrently, and/or having single stages split into multiple stages.

At stage 1902, the method includes receiving a request for a future location of a user equipment. A server 400 such as the LMF 120, including a processor 410 and a transceiver 415, is a means for receiving a request for a future location of a UE. In an example, referring to the message flow 1000, a network entity such as the LCS entity 1010 may provide a location service request message 1012 indicating a future time value T for obtaining a location of the target UE.

At stage 1904, the method includes determining time window information based on the request for the future location of the user equipment. The server 400, including the processor 410 and the transceiver 415, is a means for determining the time window information. In an example, the location service request message received at stage 1902 may also include time window information (e.g., a delta value, or other parameters) to define a period to obtain the UE location information (e.g., the preferred measurement reporting window 1104). In another embodiment, the LMF 120 may be configured to determine the time window (e.g., the delta value) based on network configuration options (e.g., PRS schedule information). The LMF 120 may be configured to provide an adjustment to the T value to a valid time to ensure the location information can be obtained. In an embodiment, the LMF 120 and an LCS entity may perform a negotiation process to determine the time T and the time window information.

At stage 1906, the method includes determining a reference signal prioritization scheme based at least in part on the time window information and a context of the user equipment. The server 400, including the processor 410, is a means for determining a reference signal prioritization scheme. The LMF 120 may be configured to utilize a reference signal prioritization scheme such as the prioritization and reporting methods depicted in FIGS. 13-18. Other prioritization schemes may also be used. In an embodiment, a prioritization scheme may be selected based on a context of the UE at the future time T. In an example, a UE may have limited capabilities to process weak signals and a measurement based prioritization such as the first method 1300 may be utilized. A time based method, such as the second method 1400, may provide improved accuracy for a slow moving UE. PRS prioritization schemes which utilize the PRS measurements on the left side of the preferred measurement reporting window 1104 may be preferable for UEs with stale position information (e.g., a larger uncertainty value associated with a current estimated position). Prioritization schemes which utilize the PRS measurements on the right side of the measurement window may be preferable for fast moving UEs. Legacy priority values (i.e., assigned to a PRS resource by a TRP) may also be used in conjunction with the preferred measurement reporting window 1104. For example, the PRS measurements may be prioritized based on the legacy priority values, but with preference given to the PRS resources transmitted within the preferred measurement reporting window 1104. The LMF 120 may be configured to provide other prioritization schemes based on the context, state, and/or capabilities of a UE. In an embodiment, a look-up-table (LUT), or other data structure, may be used to associate a prioritization scheme with the context, state, capabilities, and/or other factors associated with a target UE.

At stage 1908, the method includes providing the reference signal prioritization scheme to the user equipment. The server 400, including the processor 410 and the transceiver 415, is a means for providing the reference signal prioritization scheme to the UE. In an embodiment, referring to the message flow 1000, the LMF 120 may be configured to schedule a location procedure based on the future time T received at stage 1902 and the time window information determined at stage 1904. The LMF 120 may provide NRPPa measurement request messages and LPP request location information message including an indication of the time value T and a delta value (A) to network stations to indicate when the location measurements are to be obtained. In an embodiment, an indication of the reference signal prioritization scheme may be included in the LPP request location information message. For example, an index value associated with one of the prioritization methods such as depicted in FIGS. 13-18 may be included in an information element in the LPP request. Other signaling techniques, and prioritization methods, may also be used to enable the UE to apply a desired preferred time window based prioritization scheme.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Components, functional or otherwise, shown in the figures and/or discussed herein as being connected or communicating with each other are communicatively coupled unless otherwise noted. That is, they may be directly or indirectly connected to enable communication between them.

As used herein, the singular forms “a.” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A. B, or C,” or a list of “one or more of A, B, or C” or a list of A or B or C” means A. or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A. or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different disclosures and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for measuring positioning reference signals, comprising: obtaining positioning reference signal configuration information; obtaining preferred measurement reporting window information: determining priority values for a plurality of positioning reference signals, wherein each priority value for a respective positioning reference signal is based at least in part on the positioning reference signal configuration information and the preferred measurement reporting window information; and reporting measurement values for one or more of the plurality of positioning reference signals based on the priority value.

Clause 2. The method of clause 1 wherein the preferred measurement reporting window information includes a time value and a delta time value, wherein a preferred measurement reporting window is a period of time equal to the time value minus the delta time value to the time value plus the delta time value.

Clause 3. The method of clause 2 wherein determining the priority value for the plurality of positioning reference signals includes determining a first set of positioning reference signals to be measured inside of the preferred measurement reporting window and a second set of positioning reference signals to be measured outside of the preferred measurement reporting window, wherein each positioning reference signal in the first set of positioning reference signals will have a higher priority than any positioning reference signal in the second set of positioning reference signals.

Clause 4. The method of clause 3 wherein the first set of positioning reference signals and the second set of positioning reference signals are respectively sorted based on the measurement values for each of the positioning reference signals.

Clause 5. The method of clause 4 wherein the second set of positioning reference signals is limited to one or more positioning reference signals received to the left of the preferred measurement reporting window.

Clause 6. The method of clause 4 wherein the second set of positioning reference signals is limited to one or more positioning reference signals received to the right of the preferred measurement reporting window.

Clause 7. The method of clause 3 wherein the first set of positioning reference signals and the second set of positioning reference signals are respectively sorted based on distance values measured from the time value for each of the positioning reference signals.

Clause 8. The method of clause 7 wherein the second set of positioning reference signals is limited to one or more positioning reference signals received to the left of the preferred measurement reporting window.

Clause 9. The method of clause 7 wherein the second set of positioning reference signals is limited to one or more positioning reference signals received to the right of the preferred measurement reporting window.

Clause 10. The method of clause 7 further comprising obtaining measurements for the one or more of the plurality of positioning reference signals based on the priority value.

Clause 11. The method of clause 3 wherein the positioning reference signal configuration information includes legacy priority values for one or more positioning reference signals, and the first set of positioning reference signals and the second set of positioning reference signals are respectively sorted based at least in part on the legacy priority values for the one or more positioning reference signals.

Clause 12. The method of clause 11 further comprising obtaining measurements for the one or more of the plurality of positioning reference signals based on the legacy priority values.

Clause 13. The method of clause 1 wherein at least one of the plurality of positioning reference signals is a downlink positioning reference signal.

Clause 14. The method of clause 1 wherein at least one of the plurality of positioning reference signals is a sidelink positioning reference signal.

Clause 15. The method of clause 1 wherein at least one of the plurality of positioning reference signals is a sounding reference signal for positioning.

Clause 16. The method of clause 1 wherein the preferred measurement reporting window information is associated with a scheduled in advance measurement window.

Clause 17. A method for providing a reference signal prioritization scheme, comprising: receiving a request for a future location of a user equipment; determining time window information based on the request for the future location of the user equipment; determining the reference signal prioritization scheme based at least in part on the time window information and a context of the user equipment; and providing the reference signal prioritization scheme to the user equipment.

Clause 18. The method of clause 17 wherein the request for the future location of the user equipment is received from a location services entity.

Clause 19. The method of clause 17 wherein the request for the future location of the user equipment includes the time window information.

Clause 20. The method of clause 17 wherein the reference signal prioritization scheme includes prioritizing a first set of positioning reference signals measured within a preferred measurement reporting window over as second set of positioning reference signals measured outside of the preferred measurement reporting window.

Clause 21. The method of clause 20 wherein the reference signal prioritization scheme includes prioritizing a plurality of positioning reference signals based on measurement values obtained for each of the plurality of positioning reference signals.

Clause 22. The method of clause 20 wherein the reference signal prioritization scheme includes prioritizing a plurality of positioning reference signals based on a time that each of the plurality of positioning reference signals is measured.

Clause 23. The method of clause 20 wherein the reference signal prioritization scheme includes prioritizing a plurality of positioning reference signals based on legacy positioning reference signal priority values assigned by a base station.

Clause 24. An apparatus, comprising: a memory; at least one transceiver; at least one processor communicatively coupled to the memory and the at least one transceiver, and configured to: obtain positioning reference signal configuration information: obtain preferred measurement reporting window information; determine priority values for a plurality of positioning reference signals, wherein each priority value for a respective positioning reference signal is based at least in part on the positioning reference signal configuration information and the preferred measurement reporting window information; and report measurement values for one or more of the plurality of positioning reference signals based on the priority value.

Clause 25. The apparatus of clause 24 wherein the preferred measurement reporting window information includes a time value and a delta time value, wherein a preferred measurement reporting window is a period of time equal to the time value minus the delta time value to the time value plus the delta time value.

Clause 26. The apparatus of clause 25 wherein the at least one processor is further configured to determine a first set of positioning reference signals to be measured inside of the preferred measurement reporting window and a second set of positioning reference signals to be measured outside of the preferred measurement reporting window, wherein each positioning reference signal in the first set of positioning reference signals will have a higher priority than any positioning reference signal in the second set of positioning reference signals.

Clause 27. The apparatus of clause 26 wherein the at least one processor is further configured to sort the positioning reference signals in the first set of positioning reference signals and the second set of positioning reference signals based at least in part on the measurement values.

Clause 28. The apparatus of clause 27 wherein the second set of positioning reference signals is limited to one or more positioning reference signals received to the left of the preferred measurement reporting window.

Clause 29. The apparatus of clause 27 wherein the second set of positioning reference signals is limited to one or more positioning reference signals received to the right of the preferred measurement reporting window.

Clause 30. The apparatus of clause 26 wherein the first set of positioning reference signals and the second set of positioning reference signals are respectively sorted based on distance values measured from the time value for each of the positioning reference signals.

Clause 31. The apparatus of clause 30 wherein the second set of positioning reference signals is limited to one or more positioning reference signals received to the left of the preferred measurement reporting window.

Clause 32. The apparatus of clause 30 wherein the second set of positioning reference signals is limited to one or more positioning reference signals received to the right of the preferred measurement reporting window.

Clause 33. The apparatus of clause 30 wherein the at least one processor is further configured to obtain measurements for the one or more of the plurality of positioning reference signals based on the priority value.

Clause 34. The apparatus of clause 26 wherein the positioning reference signal configuration information includes legacy priority values for one or more positioning reference signals, and the at least one processor is further configured to respectively sort the first set of positioning reference signals and the second set of positioning reference signals based at least in part on the legacy priority values.

Clause 35. The apparatus of clause 34 wherein the at least one processor is further configured to obtain measurements for the one or more of the plurality of positioning reference signals based on the legacy priority values.

Clause 36. The apparatus of clause 24 wherein at least one of the plurality of positioning reference signals is a downlink positioning reference signal.

Clause 37. The apparatus of clause 24 wherein at least one of the plurality of positioning reference signals is a sidelink positioning reference signal.

Clause 38. The apparatus of clause 24 wherein at least one of the plurality of positioning reference signals is a sounding reference signal for positioning.

Clause 39. The apparatus of clause 24 wherein the preferred measurement reporting window information is associated with a scheduled in advance measurement window.

Clause 40. An apparatus, comprising: a memory; at least one transceiver; at least one processor communicatively coupled to the memory and the at least one transceiver, and configured to: receive a request for a future location of a user equipment; determine time window information based on the request for the future location of the user equipment; determine a reference signal prioritization scheme based at least in part on the time window information and a context of the user equipment; and provide the reference signal prioritization scheme to the user equipment.

Clause 41. The apparatus of clause 40 wherein the request for the future location of the user equipment is received from a location services entity.

Clause 42. The apparatus of clause 40 wherein the request for the future location of the user equipment includes the time window information.

Clause 43. The apparatus of clause 40 wherein the reference signal prioritization scheme includes prioritizing a first set of positioning reference signals measured within a preferred measurement reporting window over as second set of positioning reference signals measured outside of the preferred measurement reporting window.

Clause 44. The apparatus of clause 43 wherein the reference signal prioritization scheme includes prioritizing a plurality of positioning reference signals based on measurement values obtained for each of the plurality of positioning reference signals.

Clause 45. The apparatus of clause 43 wherein the reference signal prioritization scheme includes prioritizing a plurality of positioning reference signals based on a time that each of the plurality of positioning reference signals is measured.

Clause 46. The apparatus of clause 43 wherein the reference signal prioritization scheme includes prioritizing a plurality of positioning reference signals based on legacy positioning reference signal priority values assigned by a base station.

Clause 47. An apparatus for measuring positioning reference signals, comprising: means for obtaining positioning reference signal configuration information: means for obtaining preferred measurement reporting window information: means for determining priority values for a plurality of positioning reference signals, wherein each priority value for a respective positioning reference signal is based at least in part on the positioning reference signal configuration information and the preferred measurement reporting window information; and means for reporting measurement values for one or more of the plurality of positioning reference signals based on the priority value.

Clause 48. An apparatus for providing a reference signal prioritization scheme, comprising: means for receiving a request for a future location of a user equipment; means for determining time window information based on the request for the future location of the user equipment; means for determining the reference signal prioritization scheme based at least in part on the time window information and a context of the user equipment; and means for providing the reference signal prioritization scheme to the user equipment.

Clause 49. A non-transitory processor-readable storage medium comprising processor-readable instructions configured to cause one or more processors to measure positioning reference signals, comprising: code for obtaining positioning reference signal configuration information; code for obtaining preferred measurement reporting window information: code for determining priority values for a plurality of positioning reference signals, wherein each priority value for a respective positioning reference signal is based at least in part on the positioning reference signal configuration information and the preferred measurement reporting window information; and code for reporting measurement values for one or more of the plurality of positioning reference signals based on the priority value.

Clause 50. A non-transitory processor-readable storage medium comprising processor-readable instructions configured to cause one or more processors to provide a reference signal prioritization scheme, comprising: code for receiving a request for a future location of a user equipment; code for determining time window information based on the request for the future location of the user equipment; code for determining the reference signal prioritization scheme based at least in part on the time window information and a context of the user equipment; and code for providing the reference signal prioritization scheme to the user equipment.

1. A method for measuring positioning reference signals, comprising:
obtaining positioning reference signal configuration information;
obtaining preferred measurement reporting window information;
determining priority values for a plurality of positioning reference signals, wherein each priority value for a respective positioning reference signal is based at least in part on the positioning reference signal configuration information and the preferred measurement reporting window information; and
reporting measurement values for one or more of the plurality of positioning reference signals based on the priority value.

2. The method of claim 1 wherein the preferred measurement reporting window information includes a time value and a delta time value, wherein a preferred measurement reporting window is a period of time equal to the time value minus the delta time value to the time value plus the delta time value.

3. The method of claim 2 wherein determining the priority value for the plurality of positioning reference signals includes determining a first set of positioning reference signals to be measured inside of the preferred measurement reporting window and a second set of positioning reference signals to be measured outside of the preferred measurement reporting window, wherein each positioning reference signal in the first set of positioning reference signals will have a higher priority than any positioning reference signal in the second set of positioning reference signals.

4. The method of claim 3 wherein the first set of positioning reference signals and the second set of positioning reference signals are respectively sorted based on the measurement values for each of the positioning reference signals.

5. The method of claim 4 wherein the second set of positioning reference signals is limited to one or more positioning reference signals received to the left of the preferred measurement reporting window.

6. The method of claim 4 wherein the second set of positioning reference signals is limited to one or more positioning reference signals received to the right of the preferred measurement reporting window.

7. The method of claim 3 wherein the first set of positioning reference signals and the second set of positioning reference signals are respectively sorted based on distance values measured from the time value for each of the positioning reference signals.

8. The method of claim 7 wherein the second set of positioning reference signals is limited to one or more positioning reference signals received to the left of the preferred measurement reporting window.

9. The method of claim 7 wherein the second set of positioning reference signals is limited to one or more positioning reference signals received to the right of the preferred measurement reporting window.

10. The method of claim 7 further comprising obtaining measurements for the one or more of the plurality of positioning reference signals based on the priority value.

11. The method of claim 3 wherein the positioning reference signal configuration information includes legacy priority values for one or more positioning reference signals, and the first set of positioning reference signals and the second set of positioning reference signals are respectively sorted based at least in part on the legacy priority values for the one or more positioning reference signals.

12. The method of claim 11 further comprising obtaining measurements for the one or more of the plurality of positioning reference signals based on the legacy priority values.

13. The method of claim 1 wherein at least one of the plurality of positioning reference signals is a downlink positioning reference signal, a sidelink positioning reference signal, or a sounding reference signal for positioning.

14. The method of claim 1 wherein the preferred measurement reporting window information is associated with a scheduled in advance measurement window.

15. A method for providing a reference signal prioritization scheme, comprising:
receiving a request for a future location of a user equipment;
determining time window information based on the request for the future location of the user equipment;
determining the reference signal prioritization scheme based at least in part on the time window information and a context of the user equipment; and
providing the reference signal prioritization scheme to the user equipment.

16. The method of claim 15 wherein the request for the future location of the user equipment is received from a location services entity.

17. The method of claim 15 wherein the request for the future location of the user equipment includes the time window information.

18. The method of claim 15 wherein the reference signal prioritization scheme includes prioritizing a first set of positioning reference signals measured within a preferred measurement reporting window over as second set of positioning reference signals measured outside of the preferred measurement reporting window.

19. The method of claim 18 wherein the reference signal prioritization scheme includes prioritizing a plurality of positioning reference signals based on measurement values obtained for each of the plurality of positioning reference signals.

20. The method of claim 18 wherein the reference signal prioritization scheme includes prioritizing a plurality of positioning reference signals based on a time that each of the plurality of positioning reference signals is measured.

21. The method of claim 18 wherein the reference signal prioritization scheme includes prioritizing a plurality of positioning reference signals based on legacy positioning reference signal priority values assigned by a base station.

22. An apparatus, comprising:
a memory;
at least one transceiver;
at least one processor communicatively coupled to the memory and the at least one transceiver, and configured to:
obtain positioning reference signal configuration information;
obtain preferred measurement reporting window information;
determine priority values for a plurality of positioning reference signals, wherein each priority value for a respective positioning reference signal is based at least in part on the positioning reference signal configuration information and the preferred measurement reporting window information; and
report measurement values for one or more of the plurality of positioning reference signals based on the priority value.

23. The apparatus of claim 22 wherein the preferred measurement reporting window information includes a time value and a delta time value, wherein a preferred measurement reporting window is a period of time equal to the time value minus the delta time value to the time value plus the delta time value.

24. The apparatus of claim 23 wherein the at least one processor is further configured to determine a first set of positioning reference signals to be measured inside of the preferred measurement reporting window and a second set of positioning reference signals to be measured outside of the preferred measurement reporting window, wherein each positioning reference signal in the first set of positioning reference signals will have a higher priority than any positioning reference signal in the second set of positioning reference signals.

25. The apparatus of claim 24 wherein the at least one processor is further configured to sort the positioning reference signals in the first set of positioning reference signals and the second set of positioning reference signals based at least in part on the measurement values.

26. The apparatus of claim 24 wherein the first set of positioning reference signals and the second set of positioning reference signals are respectively sorted based on distance values measured from the time value for each of the positioning reference signals.

27. The apparatus of claim 24 wherein the positioning reference signal configuration information includes legacy priority values for one or more positioning reference signals, and the at least one processor is further configured to respectively sort the first set of positioning reference signals and the second set of positioning reference signals based at least in part on the legacy priority values.

28. An apparatus, comprising:
a memory;
at least one transceiver;
at least one processor communicatively coupled to the memory and the at least one transceiver, and configured to:
receive a request for a future location of a user equipment;
determine time window information based on the request for the future location of the user equipment;
determine a reference signal prioritization scheme based at least in part on the time window information and a context of the user equipment; and
provide the reference signal prioritization scheme to the user equipment.

29. The apparatus of claim 28 wherein the reference signal prioritization scheme includes prioritizing a first set of positioning reference signals measured within a preferred measurement reporting window over as second set of positioning reference signals measured outside of the preferred measurement reporting window.

30. The apparatus of claim 28 wherein the reference signal prioritization scheme includes prioritizing a plurality of positioning reference signals based on a time that each of the plurality of positioning reference signals is measured.
